(19) United States
(12) Patent Application Publication
(10) Pub. No.: US 2025/0073676 A1
(43) Pub. Date: Mar. 6, 2025

(54) SEPARATION MATRICES AND METHODS FOR LIQUID CHROMATOGRAPHY WITH IMPROVED LINEAR FLOW VELOCITY

(71) Applicant: Purolite LLC, King of Prussia, PA (US)

(72) Inventor: Serguei Rudolfovich Kosvintsev, Llantrisant (GB)

(21) Appl. No.: 18/820,678

(22) Filed: Aug. 30, 2024

Related U.S. Application Data
(60) Provisional application No. 63/580,066, filed on Sep. 1, 2023.

(51) Int. Cl. B01J 20/28; B01D 15/10; B01J 13/00; B01J 20/24; B01J 20/26; B01J 20/291

(52) U.S. Cl. CPC B01J 20/28004; B01D 15/10; B01J 13/0086; B01J 20/24; B01J 20/267; B01J 20/28019; B01J 20/28047; B01J 20/291

(57) ABSTRACT

Methods of performing liquid chromatography using a mobile phase and a stationary phase, wherein the stationary phase includes a separation matrix comprising spheroidal polymer beads prepared by dispersing a hydrocolloid or other gel forming compound or a water-soluble polymerizable monomer through a plurality of holes in a membrane under conditions sufficient to form beads with a volume median particle diameter of less than about 300 μm and a SPAN of less than 0.6 to increase linear flow velocity (cm/h) of the mobile phase compared to polymer beads having a SPAN of 0.6 or greater are disclosed. Methods of increasing linear flow velocity of the mobile phase as well as separation matrices are further disclosed.

### CROSS REFERENCE TO RELATED APPLICATIONS

This application claims priority under 35 U.S.C. § 119 to provisional patent application U.S. Ser. No. 63/580,066, filed Sep. 1, 2023. The provisional patent application is herein incorporated by reference in its entirety.

### TECHNICAL FIELD

The disclosure relates to the field of liquid chromatography, and more specifically relates to methods of performing liquid chromatography, including ion exchange chromatography or affinity chromatography, preferably affinity chromatography, using a mobile phase and a stationary phase, wherein the stationary phase includes a separation matrix comprising spheroidal polymer beads prepared by dispersing a hydrocolloid or other gel forming compound or a water-soluble polymerizable monomer through a plurality of holes in a membrane under conditions sufficient to form beads with a volume average particle diameter of less than about 300 μm and a SPAN of less than 0.6 to beneficially permit an increased linear flow velocity (cm/h) of the mobile phase compared to polymer beads having a SPAN of 0.6 or greater.

### BACKGROUND

Liquid chromatography includes ion exchange chromatography and affinity chromatography. In ion exchange chromatography, molecules are separated according to the strength of their overall ionic interaction with a stationary phase. Affinity chromatography is used to isolate and purify biomolecules such as proteins and includes, for example, monoclonal antibody purification. In affinity chromatography, ligands are used for binding the biomolecules to the stationary phase.

The stationary phase in liquid chromatography is preferably a polymer bead substrate prepared using various methods known in the industry. There have been various developments and improvements to these methods to improve costs, output and other aspects of the polymer beads themselves. U.S. Pat. No. 6,602,990 B1 discloses a process for producing a porous cross-linked polysaccharide gel for use as a stationary phase in affinity chromatography. The gel includes polymer agarose beads described as highly rigid, and the patent demonstrates that the highly rigid beads can withstand the use of high flow rates to increase speed of affinity chromatography. The polymer agarose beads are prepared using stirred reactor emulsification. U.S. Pat. No. 10,995,113 B2 discloses a separation matrix for use in affinity chromatography. The separation matrix includes rigid cross-linked agarose beads prepared by the method disclosed in U.S. Pat. No. 6,602,990B2. WO2018/109149 discloses a large-scale, high-output method for preparing polymer beads with a narrow particle size distribution (i.e., they are uniform beads). The method is known as ‘jetting’ or ‘jet flow’, as monomer or polymer is dispersed under pressure through a plurality of holes in a membrane in a jet flow.

There have also been significant developments in various engineered protein ligands for use in affinity chromatography. For example, protein ligands can enhance selecting and isolation of targeted materials, improve ability of separation media to withstand cleaning procedures without capacity loss, and other operational conditions.

However, there remains a need in the art for enhanced performance of the liquid chromatography itself, such as namely the rate at which a mobile phase passes through a stationary phase which is measured according to the mobile phase linear flow velocity (cm/h).

It is therefore an object of this disclosure to provide improved methods for liquid chromatography, preferably affinity chromatography.

It is a further object of this disclosure to provide methods for increasing linear flow velocity (cm/h) of a mobile phase moving through a stationary phase in a liquid chromatography process.

Still further it is an object to provide separation matrices for employing a mobile phase to pass through a column housing a stationary phase at an increased linear flow velocity (cm/h).

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

According to some aspects of the present disclosure, methods of performing liquid chromatography, comprise: contacting a mobile phase and a stationary phase within a column, wherein the stationary phase comprises a separation matrix comprising spheroidal polymer beads prepared by dispersing a hydrocolloid or other gel forming compound or a water-soluble polymerizable monomer through a plurality of holes in a membrane under conditions sufficient to form spheroidal polymer beads having a volume median particle diameter up to about 300 μm; wherein the mobile phase linear flow velocity (cm/h) is increased when the spheroidal polymer beads have a SPAN of less than about 0.6 compared to spheroidal polymer beads having a SPAN of more than 0.6.

According to further aspects of the present disclosure, methods of increasing linear flow velocity (cm/h) of a mobile phase moving through a stationary phase in a liquid chromatography process comprise: contacting a mobile phase and a stationary phase within a column, wherein the stationary phase comprises a separation matrix comprising spheroidal polymer beads prepared by dispersing a hydrocolloid or other gel forming compound or a water-soluble polymerizable monomer through a plurality of holes in a membrane under conditions sufficient to form spheroidal polymer beads having a volume median particle diameter up to about 300 μm; and wherein a linear flow velocity (cm/h) of the mobile phase is increased by the use of spheroidal polymer beads having a SPAN of less than about 0.6.

According to further aspects of the present disclosure, separation matrices for liquid chromatography, comprise: a stationary phase housed within a column, wherein the stationary phase comprises a separation matrix comprising spheroidal polymer beads prepared by dispersing a hydrocolloid or other gel forming compound or a water-soluble polymerizable monomer through a plurality of holes in a membrane under conditions sufficient to form spheroidal polymer beads having a volume average particle diameter up to about 300 μm and having a SPAN of less than about 0.6, wherein the stationary phase permits a mobile phase to pass through the stationary phase in the column at an increased linear flow velocity (cm/h) compared to a stationary phase comprising spheroidal polymer beads having a SPAN greater than 0.6.

According to the various aspects of the disclosure, the methods and separation matrix beneficially increase the linear flow velocity (cm/h) of a mobile phase passing through the stationary phase in the column compared to a stationary phase comprising spheroidal polymer beads having a SPAN greater than 0.6. In comparison to the beads disclosed in U.S. Pat. Nos. 6,602,990 and 10,995,113, which are described by the patentee as being rigid, the spheroidal polymer beads used in the present invention are non-rigid in addition to having a volume average particle diameter up to about 300 μm and having a SPAN of less than about 0.6.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 is a schematic representation illustrating a reactor unit as described herein for preparing uniform spheroidal polymer beads with a narrow particle size distribution.

FIG. 2 is a schematic representation illustrating a can-shaped membrane as described herein for preparing uniform spheroidal polymer beads.

FIG. 3 shows a graph of the particle size distribution measured for polymer beads prepared using stirred reactor emulsification described as Comparative Example 1 as described in Example 1.

FIG. 4 shows a graph of the particle size distribution measured for spheroidal polymer beads described as Example 1 as described in Example 1.

FIG. 5 shows a graph of the particle size distribution spread measured for polymer beads prepared using stirred reactor emulsification described as Comparative Example 2 as described in Example 1.

FIG. 6 shows a graph of the particle size distribution spread measured for spheroidal polymer beads described as Example 2 as described in Example 1.

FIG. 7 shows a graph of the particle size distribution measured for polymer beads prepared using stirred reactor emulsification described as Comparative Example 3 as described in Example 1.

FIG. 8 shows a graph of the particle size distribution spread measured for spheroidal polymer beads described as Example 3 as described in Example 1.

FIG. 9 shows a graph of the particle size distribution measured for polymer beads prepared using stirred reactor emulsification described as Comparative Example 4 as described in Example 1.

FIG. 10 shows a graph of the particle size distribution spread measured for spheroidal polymer beads described as Example 4 as described in Example 1.

FIG. 11 shows a graph of the particle size distribution spread measured for polymer beads prepared using stirred reactor emulsification described as Comparative Example 5 as described in Example 1.

FIG. 12 shows a graph of the particle size distribution spread measured for a spheroidal polymer bead described as Example 5 as described in Example 1.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, such as particular methodologies, protocols, and reagents as described, as these may vary and are understood by skilled artisans. No features shown or described are essential to permit basic operation of the present disclosure unless otherwise indicated. It has been surprisingly found that jetted polymer beads having a substantially uniform particle size permit improved methods of liquid chromatography, preferably affinity chromatography, through use of increased flow velocity.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. This applies regardless of the breadth of the range.

All publications, including all patents, patent applications and other patent and non-patent publications cited or mentioned herein are incorporated herein by reference for at least the purposes that they are cited; including for example, for the disclosure or descriptions of methods of materials which may be used. Nothing herein is to be construed as an admission that a publication or other reference (including any reference cited in the Background section) is prior art to the invention or that the invention is not entitled to antedate such disclosure, for example, by virtue of prior invention.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods of the present disclosure may comprise, consist essentially of, or consist of the components and steps described as well as other components and steps described herein. As used herein, “consisting essentially of” means that the methods may include additional components and steps, but only if the additional components and steps do not materially alter the basic and novel characteristics of the claimed methods.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, size, time, temperature, pH, humidity, molar ratios, and the like. The term “about” also encompasses these variations. Whether or not modified by the term “about,” the claims include equivalents to the quantities.

As used herein, the term “between” is inclusive of any endpoints noted relative to a described range.

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

As used herein, the term “exemplary” refers to an example, an instance, or an illustration, and does not indicate a most preferred embodiment unless otherwise stated.

The term “generally” encompasses both “about” and “substantially.”

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, sub-combinations, or the like that would be obvious to those skilled in the art.

The term “substantially” refers to a great or significant extent. “Substantially” can thus refer to a plurality, majority, and/or a supermajority of said quantifiable variable, given proper context.

Methods to produce uniform spheroidal polymer beads having substantially uniform particle size are disclosed in WO2018/109149, which is incorporated herein by reference in its entirety. The methods for making spheroidal polymer beads include dispersing a hydrocolloid or other gel forming polymerizable compound or a water-soluble polymerizable monomer through a plurality of holes in a membrane under conditions sufficient to form uniform spheroidal polymer beads having a volume median particle diameter up to about 300 μm and a SPAN of less than about 0.6. Beneficially screening is not required; however, a single coarse screening step may be employed to remove particles that are too big (for example, polymer beads greater than 250 μm, preferably greater than 200 μm) or any unwanted contaminants, which minimizes a reduction in the amount of polymer beads produced, such as in comparison to a polymer bead that is prepared using stirred reactor emulsification and has an increased SPAN and employs multiple screening steps.

Generally the methods utilize a dispersed phase containing mixtures of one or more co-polymerizable monomers, or mixtures of one or more copolymerizable monomers, or a hydrocolloid (e.g. dextrose and agarose or other polysaccharide) or other gel forming compound (e.g. PEG, PVA) with a non-polymerizable material (e.g., an inert porogenic or pore-forming material, pre-polymer, or the like) that are forced through a plurality of holes in a membrane to form dispersed phase droplets in a reactor unit. In embodiments the membrane is a vibrating membrane. In embodiments the membrane is metal, such as nickel, chrome plated nickel or stainless steel. The dispersed phase droplets flow into a liquid phase in a jet flow that breaks into drops that are substantially uniform in size.

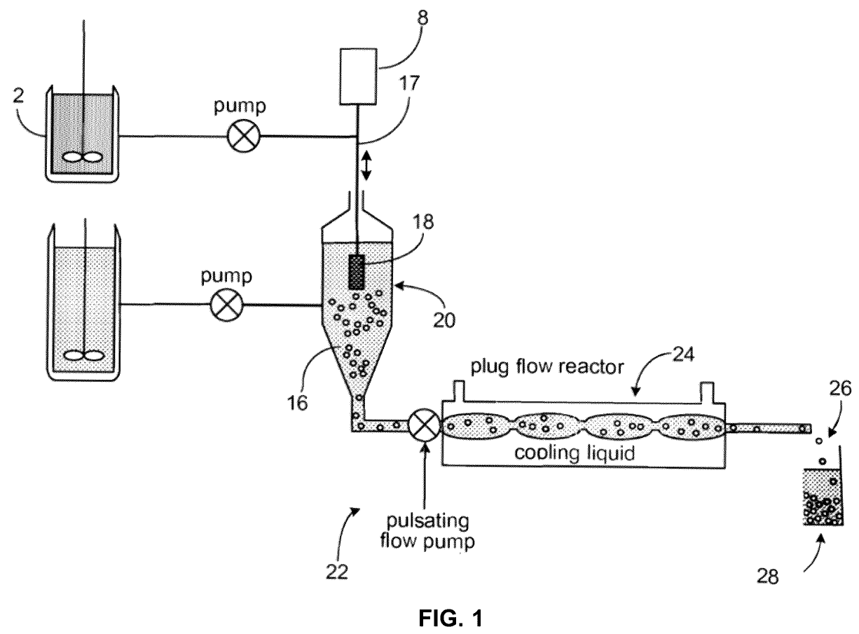

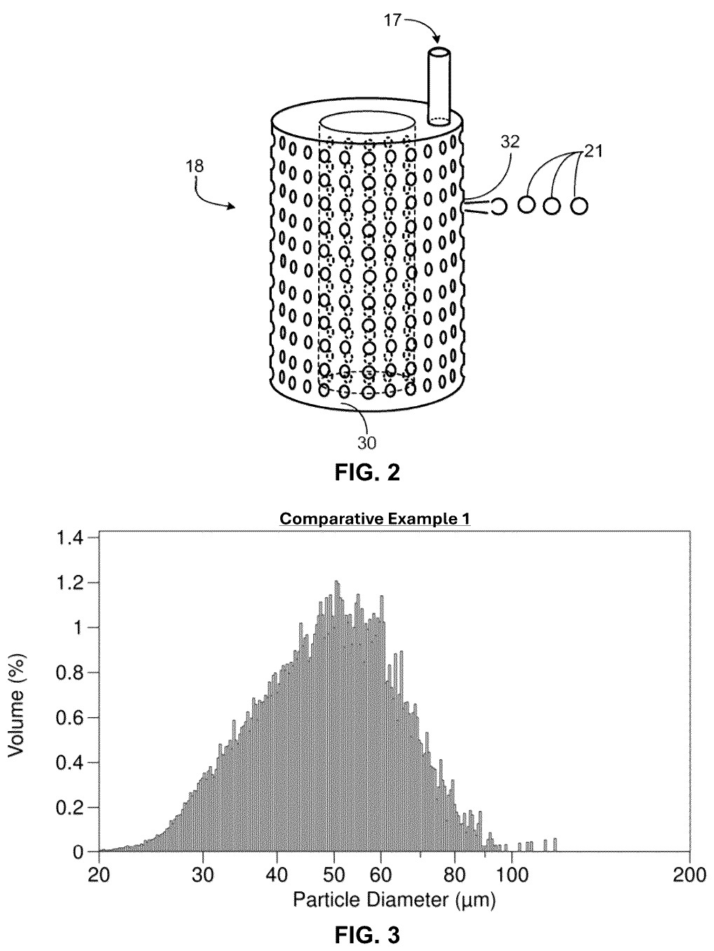

These methods are further described based on the apparatus used to prepare the spheroidal polymer beads. FIG. 1 depicts a reactor unit 20 having a jet-forming membrane 18 which connects with a feed tube 17 attached to a reservoir 2. A shaker for vibrating the membrane 18 includes a vibrator 8 which incorporates the feed tube 17. The vibrator is connected by electrical contact to a variable frequency (oscillating) electrical signal generator (not shown) in a manner so that the vibrator 8 vibrates at the frequency generated by the oscillating signal generator. FIG. 2 depicts membrane 18 which includes an annulus 30 containing a dispersed phase (polymerizable monomer or hydrocolloid). Membrane 18 is supplied with the dispersed phase via feeding tube 17. Membrane 18 is also suspended in a liquid phase 16 of a suspension medium containing a liquid immiscible with the dispersed phase. The membrane 18 is configured in the shape of a double-walled can or cylinder comprising an outer cylindrical component with a continuous side wall, and an inner cylindrical component with a continuous side wall enclosing the annulus. As shown in FIG. 2, the side wall of the inner component is spaced inwardly from the side wall of the outer component and includes a constant diameter throughout the height of the outer wall. The side wall of the inner component and the side wall of the outer component include continuous upper and bottom rims and the rims are joined to form an airtight compartment between the inner and outer components. The inside and outside wall of membrane 18 includes through-holes (or pores) 32. The cylindrical double-walled shape of membrane 18 ensures that equal force/acceleration is obtained in every pore 32 on the membrane 18. This is necessary to ensure uniform bead generation.

In operation, a dispersed phase includes a phase containing mixtures of one or more co-polymerizable monomers, or mixtures of one or more copolymerizable monomers, or hydrocolloid (such as dextrose and agarose, (polysaccharides)) or other gel forming compound (such as PEG, PVA) with a non-polymerizable material (e.g., an inert porogenic or pore-forming material, pre-polymer, or the like) is introduced to the feed tube 17 via the reservoir feed 2 and is deposited in (or fills) the annulus 30 in the membrane 18. The dispersed phase is fed into the feed tube 17 at a rate such that the dispersed phase is forced through pores 32 of membrane 18 into liquid phase 16 at a rate sufficient to form jets having flow characteristics to form a plurality of dispersed phase droplets 21. The dispersed phase droplets are generated directly into a reactor unit 20. As the dispersed phase jet flows into liquid phase 16, the jet is excited at a frequency which breaks the jet into droplets. In general, membrane 18 is excited using suitable conditions so that substantially uniform sized droplets are prepared.

The particular conditions at which the droplets are formed depend on a variety of factors, particularly the desired size and uniformity of the resulting droplets and the resulting spheroidal polymer beads. In general, the dispersed bead droplets are preferably prepared to have a coefficient of variance of particle size distribution of less than about 20%, more preferably less than about 15%. Most preferably, the coefficient of variance of the particle size of the monomer droplets is less than about 10%. After forming the dispersed phase droplets, the subsequent polymerization or gel formation of the dispersed phase is performed using conditions which do not cause significant coalescence or additional dispersion and that will result in the formation of spheroidal polymer beads having a particle size such that at least about 50 volume percent have a particle diameter from about 0.9 to about 1.1 times the average particle diameter of the beads. Advantageously, at least about 60 volume percent, preferably 70 volume percent, more preferably at least about 75 volume percent of the beads exhibit such particle size. The spheroidal polymer beads have a volume median particle diameter between about 1 μm to about 300 μm. The median volume diameter of the polymer bead is preferably between about 1 μm and about 250 μm, more preferably between about 10 to about 200 μm, or about 35 to about 180 μm with additional preferred ranges of between about 40 μm to about 180 μm, about 100 to about 160 μm.

Methods of making spheroidal polymer beads are highly efficient and productive for preparing substantially uniform sized spheroidal polymer beads from one or more co-polymerizable monomers, or mixtures of one or more copolymerizable monomers, or hydrocolloid or other gel forming compounds. The spheroidal polymer beads have a spheroidal shape that is substantially uniform in size. By the term “substantially uniform” is meant that droplets exhibit a particle size distribution having a coefficient of variance (i.e., the standard deviation of the population divided by the population mean) of less than about 30%, less than about 25%, less than about 20%, less than about 15%, or less than about 10%. In embodiments the coefficient of variance of particle size is less than about 15%. In preferred embodiments the coefficient of variance of particle size is less than about 10%.

The spheroidal polymer beads have a size distribution spread (also referred to as SPAN or SPAN of distribution), referring to the range of sizes of the polymer beads and defined as (D90−D10)/D50 or the diameter of a bead at 90% volume minus the diameter at 10% volume divided by the diameter of the bead at 50% volume, to provide a dimensionless normalized to median size distribution spread at 80%. In embodiments the SPAN of the jetted polymer beads is less than about 0.6, less than about 0.5, less than about 0.45, less than about 0.4, or less than about 0.3.

The spheroidal polymer beads do not significantly coalesce and results in the formation of spheroidal polymer beads having a particle size such that at least about 50 volume percent, at least about 70 volume percent, or at least about 90 volume percent, of the beads have a particle diameter from about 0.9 to about 1.1 times the average particle diameter of the beads.

The spheroidal polymer beads are spheroidal polymer beads having a volume median particle diameter (i.e., the median diameter based on the 50% volume of the particle) between about 1 μm (micrometer or also referred to as micron) to about 300 μm. The volume median diameter of the polymer bead of the invention is preferably between about 1 μm and about 300 μm, between about 1 μm and about 200 μm, between about 1 μm and about 120 μm, between about 1 μm and about 100 μm, or between about 20 μm and about 100 μm. The spheroidal polymer beads can be finetuned to desired drop sizes and achieving high production of polymer beads with well-defined particle size distributions.

The volume median particle diameter can be measured by any conventional method, for example, using optical imaging, laser diffraction or electrozone sensing. Electrozone sensing involves the analysis of particle samples immersed in a conducting aqueous solution, in which an anode and a cathode are formed in shape of orifice. The particles are pumped through the orifice under pressure. Each particle displaces an amount of liquid as it passes through the orifice and causes a disruption in the electric field. The extent of the disruption corresponds to the size of the particle, and by measuring the number and size of the changes in impedance, it is possible to track particle distribution. The particle diameter may also be measured using optical microscopy or by employing other conventional techniques such as those described in U.S. Pat. No. 4,444,961.

Various polymer bead materials can be used to form the dispersed phase for the methods of preparation. In a preferred embodiment hydrocolloids and gel forming compounds are used in the dispersed phase. An exemplary hydrocolloid is agarose which forms an aqueous solution in water, where the resulting solution is sufficiently insoluble in one or more other suspension liquids, generally a water-immiscible oil or the like, such that the agarose or gel forming compound solution forms droplets upon its dispersion in the liquid. Representative water soluble hydrocolloids include a dispersed phase which can be formed into a gel using any means well described in the literature and using techniques well known in the art. Subsequent crosslinking of the gel beads formed as above is accomplished as per available publications and using techniques well known in the art.

Water soluble polymerizable monomers are also included in the scope of the present invention. For example, the invention contemplates the use of monomers that form an aqueous solution in water, where the resulting solution is sufficiently insoluble in one or more other suspension liquids, generally a water-immiscible oil or the like, such that the monomer solution forms droplets upon its dispersion in the liquid. Representative water soluble monomers include monomers which can be polymerized using conventional water-in-oil suspension (i.e., inverse suspension) polymerization techniques such as described by U.S. Pat. No. 2,982,749, including ethylenically unsaturated carboxamides such as acrylamide, methacrylamide, fumaramide and ethacrylamide; aminoalkyl esters of unsaturated carboxylic acids and anhydrides; ethylenically unsaturated carboxylic acids, e.g., acrylic or methacrylic acid, and the like. Preferred monomers for use herein are ethylenically unsaturated carboxamides, particularly acrylamide, and ethylenically unsaturated carboxylic acids, such as acrylic or methacrylic acid. The monomers can be polymerized using free radical initiation by UV light or heat, or a combination of these methods. In general, chemical radical initiators are preferably used. Free radical initiators such as persulfates, hydrogen peroxides or hydroperoxides can also be used. Typically, the ratio of organic initiator to dry monomer is about 0.1 to about 8%, or about 0.5 to about 2% by weight, preferably about 0.8 to about 1.5% by weight.

The suspension phase is a water-immiscible oil, preferably selected from halogenated hydrocarbons such as methylene chloride, liquid hydrocarbons, preferably having about 4 to about 15 carbon atoms, including aromatic and aliphatics hydrocarbons, or mixtures thereof such as heptane, benzene, xylene, cyclohexane, toluene, minerals oils and liquid paraffins. The viscosity of the suspension phase is advantageously selected such that the monomer can easily move throughout the suspension phase. In general, droplet formation is readily achieved, and movement of the droplets throughout the suspension medium is facilitated, when the viscosity of the suspension phase is higher or substantially similar (e.g., of the same order of magnitude) as the viscosity of the dispersed phase. Preferably, the suspension medium has a viscosity of less than about 50 centipoise units (cps) at room temperature. Viscosity values of less than 10 cps are preferred. In one embodiment, the viscosity of the suspension phase is from about 0.1 to about 2 times the viscosity of the dispersed phase. Viscosity modifiers such as ethyl cellulose are suitable for use in the water immiscible oil suspension phase. The suspension phase may include a suspending agent such as, for example, a surfactant with an HLB (hydrophilic-lipophilic balance) of below 5. Preferably, the total amount of suspending agent in the aqueous phase is from 0.05% to 4%, more preferably 0.5% to 2%.

The polymerizable monomer droplets are formed by dispersing the monomer phase through the plurality of pores 32 of membrane into suspension phase. The monomer linear flow rates through the membrane can vary from 1-50 cm/s, preferably 40, 30, 20 or less than 10 cm/s. The monomer droplets may be directed into the suspension phase by pumping or applying pressure (or combination of pressurizing and pumping) to direct the dispersed phase into the suspension, preferably by pumping. The applied pressure may be range from 0.01 to 4 bar, preferably 0.1 to 1 bar. A piston or similar means such as a diaphragm may also be used for directing the dispersed phase into the suspension.

The polymerization reaction vessel 20 is advantageously agitated or stirred to prevent significant coalescence or additional dispersion of the monomer droplets during the polymerization. In general, the conditions of agitation are selected such that the monomer droplets are not significantly resized by the agitation, the monomer droplets do not significantly coalesce in the reaction vessel, no significant temperature gradients develop in the suspension and pools of monomer, which may polymerize to form large masses of polymer, are substantially prevented from forming in the reaction vessel. In general, these conditions can be achieved using an agitator (paddle) which is of the anchor or gate types, or is of the ‘loop’ or ‘egg beater’ types. Preferably, the agitator bars extend up through the surface of the suspension as shown in FIG. 1, thereby preventing formation of monomer pools on the surface of the suspension.

Upon completion of polymerization, the resulting polymer beads may be recovered by convention techniques such as filtration. The recovered beads can then be further processed. Advantageously, the beads will only need a single coarse screening to remove, for example, beads greater than 250 μm, preferably greater than 200 μm.

The spheroidal polymer beads can be referred to generally as cross-linked materials. In a preferred embodiment, the spheroidal polymer beads are cross-linked polysaccharides, including for example, agarose, agar, cellulose, dextran, starch, etc. In a preferred embodiment, the spheroidal polymer beads are cross-linked agarose particles which are beneficially generally stable in various cleaning solutions used in liquid chromatography, including affinity chromatography.

The spheroidal polymer beads can be chemically modified, such as by the attachment of active ion exchange groups to form ion exchange resins. The spheroidal polymer beads can be functionalized to include desired chemical groups. These spheroidal polymer beads are particularly useful for chromatographic applications of use. For example, the spheroidal polymer beads can be used as substrates for ion exchange resins, as seeds for preparation of larger uniform polymer particles, or other uses. As referred to herein in describing particular methods of using the spheroidal polymer beads for liquid chromatography, including affinity chromatography, the spheroidal polymer beads further comprise a ligand bound thereto, embodiments of which are not intended to be limited according to the methods described herein.

In embodiments the spheroidal polymer beads are used in liquid chromatography with numerous improved aspects of such applications of use, including one or more of the following benefits: increased flow velocity (expressed as linear flow velocity measured by cm/h) of a mobile phase when the spheroidal polymer beads have a SPAN of less than about 0.6, reduced frequency for screening fluids in the separation matrix containing the spheroidal polymer beads, and thereby reducing waste or discharged fluids from the separation matrix. These benefits are achieved compared to spheroidal polymer beads having a SPAN more than about 0.6 and fail to provide the same benefits.

In embodiments, methods of performing liquid chromatography comprise contacting a mobile phase and a stationary phase within a column, wherein the stationary phase comprises a separation matrix comprising spheroidal polymer beads prepared by dispersing a hydrocolloid or other gel forming compound or water soluble polymerizable monomer through a plurality of holes in a membrane under conditions sufficient to form uniform spheroidal polymer beads having a volume median particle diameter up to about 300 μm; wherein the mobile phase linear flow velocity (cm/h) is increased when the spheroidal polymer beads have a SPAN of less than about 0.6 compared to spheroidal polymer beads having a SPAN of more than 0.6

In embodiments, methods of increasing linear flow velocity (cm/h) of a mobile phase moving through a stationary phase in a liquid chromatography process comprise: contacting a mobile phase and a stationary phase within a column, wherein the stationary phase comprises a separation matrix comprising spheroidal polymer beads prepared by dispersing a hydrocolloid or other gel forming compound or water soluble polymerizable monomer through a plurality of holes in a membrane under conditions sufficient to form spheroidal polymer beads having a volume median particle diameter up to about 300 μm; and wherein a linear flow velocity (cm/h) of the mobile phase is increased by the use of spheroidal polymer beads having a SPAN of less than about 0.6.

In addition to the various methods, separation matrices comprise: a stationary phase housed within a column, wherein the stationary phase comprises a separation matrix comprising spheroidal polymer beads prepared by dispersing a hydrocolloid or other gel forming compound or water soluble polymerizable monomer through a plurality of holes in a membrane under conditions sufficient to form spheroidal polymer beads having a volume median particle diameter up to about 300 μm and having a SPAN of less than about 0.6, wherein the stationary phase permits a mobile phase to pass through the stationary phase in the column at an increased linear flow velocity (cm/h) compared to a stationary phase comprising spheroidal polymer beads having a SPAN greater than 0.6.

The methods and the separation matrix employing the spheroidal polymer beads can include the uniform spheroidal polymer beads as a solid support for a ligand(s) (which can also be referred to as a polypeptide) to be bound thereto. Suitable methods of immobilization and/or purification of the ligands with the spheroidal polymer beads can be carried out using standard methods in the field. Various ligands are suitable for use with the spheroidal polymer beads in order to obtain quantities of the ligand binding partner. In embodiments ligands are generally covalently coupled to the spheroidal polymer beads. In an embodiment, exemplary ligands and ligand binding partners include for example, antibodies/antigens, enzyme/substrate, and enzyme/inhibitors.

The methods and the separation matrix employing the spheroidal polymer beads can include repeating the general steps of performing liquid chromatography multiple times, such as at least 10 times, at least 20 times, at least 30 times, at least 40 times, at least 50 times, at least 60 times, at least 70 times, at least 80 times, at least 90 times, at least 100 times, or more.

In embodiments the linear flow velocity of the mobile phase is increased using the spheroidal polymer beads when compared to spheroidal polymer beads and those spheroidal polymer beads having a SPAN greater than 0.6. In embodiments the increased linear flow velocity of the mobile phase is achieved under a pressure flow of from about 0.2 MPa (2 bar) to about 0.5 MPa (5 bar), from about 0.2 MPa (2 bar) to about (0.4 MPa) 4 bar, from about 0.2 MPa (2 bar) to about 0.3 MPa (3 bar), from about 0.3 MPa (3 bar) to about 0.5 MPa (5 bar), or from about 0.3 MPa (3 bar) to about 0.4 MPa (4 bar). In preferred embodiments the pressure flow is fixed during the methods described herein.

In embodiments the flow velocity of the methods using the spheroidal polymer beads having a SPAN of less than 0.6 increases the flow velocity compared to spheroidal polymer beads having a SPAN greater than 0.6 when compared at the same pressure flow measured at about 0.3 MPa (3 bar). This improvement over a comparative pressure flow is further beneficial in not requiring a maximum pressure that would increase the likelihood of approaching thresholds for the collapse of a chromatography bed or a column housing a separation matrix. The methods of using spheroidal polymer beads having a SPAN of less than 0.6 overcomes shortcomings of the state of the art that have continued to use increasing flow rates to achieve maximum back pressures, such as continuing to increase flow rates until a diminished rate is observed at increased or even a maximum back pressure causing damage to the chromatography bed or a column housing a separation matrix.

In embodiments the methods and separation matrix employ a mobile phase pressure flow that is less than about 0.5 MPa, or from about 0.3 MPa to about 0.5 MPa. In embodiments the methods and separation matrix achieve a mobile phase linear flow velocity that is increased with the use of the spheroidal polymer beads compared to polymer beads prepared by stirred reactor emulsification (i.e., spheroidal polymer beads having a SPAN greater than 0.6). In embodiments this increase in linear flow velocity is at least about 50 cm/hr, at least about 100 cm/hr, at least about 200 cm/hr, or at least about 250 cm/hr compared to the linear flow velocity using the same polymer beads prepared by stirred reactor emulsification (i.e., spheroidal polymer beads having a SPAN greater than 0.6).

In embodiments this increase in linear flow velocity is increased by at least about 10%, at least about 20%, at least about 30%, or at least about 40% compared to the linear flow velocity using the same polymer beads prepared by stirred reactor emulsification (i.e., spheroidal polymer beads having a SPAN greater than 0.6).

### EMBODIMENTS

The present disclosure is further defined by the following numbered embodiments:
1. A method of performing liquid chromatography, comprising: contacting a mobile phase and a stationary phase within a column, wherein the stationary phase comprises a separation matrix comprising spheroidal polymer beads prepared by dispersing a hydrocolloid or other gel forming compound or a water-soluble polymerizable monomer through a plurality of holes in a membrane under conditions sufficient to form spheroidal polymer beads having a volume median particle diameter up to about 300 μm; wherein the mobile phase linear flow velocity (cm/h) is increased when the spheroidal polymer beads have a SPAN of less than about 0.6 compared to spheroidal polymer beads having a SPAN of more than 0.6.
2. The method of embodiment 1, wherein the mobile phase flow pressure is between less than about 0.5 MPa, or from about 0.3 MPa to about 0.5 MPa.
3. The method of any one of embodiments 1-3, wherein the mobile phase linear flow velocity is increased with the use of the spheroidal polymer beads compared to polymer beads prepared by stirred reactor emulsification.
4. The method of any one of embodiments 1-3, wherein the increase in linear flow velocity is at least about 50 cm/hr compared to the linear flow velocity using the same polymer beads prepared by stirred reactor emulsification.
5. The method of any one of embodiments 1-3, wherein the increase in linear flow velocity is at least about 100 cm/hr compared to the linear flow velocity using the same polymer beads prepared by stirred reactor emulsification.
6. The method of any one of embodiments 1-3, wherein the increase in linear flow velocity is at least about 200 cm/hr compared to the linear flow velocity using the same polymer beads prepared by stirred reactor emulsification.
7. The method of any one of embodiments 1-3, wherein the increase in linear flow velocity is at least about 250 cm/hr compared to the linear flow velocity using the same polymer beads prepared by stirred reactor emulsification.
8. The method of any one of embodiments 1-3, wherein the linear flow velocity is increased by at least about 10% compared to the linear flow velocity using the same polymer beads prepared by stirred reactor emulsification.
9. The method of any one of embodiments 1-3, wherein the linear flow velocity is increased by at least about 20% compared to the linear flow velocity using the same polymer beads prepared by stirred reactor emulsification.
10. The method of any one of embodiments 1-3, wherein the linear flow velocity is increased by at least about 30% compared to the linear flow velocity using the same polymer beads prepared by stirred reactor emulsification.
11. The method of any one of embodiments 1-3, wherein the linear flow velocity is increased by at least about 40% compared to the linear flow velocity using the same polymer beads prepared by stirred reactor emulsification.
12. The method of any one of embodiments 1-11, wherein the spheroidal polymer beads have substantially uniform particle size as measured by a particle size distribution having a uniformity coefficient of less than about 1.2 or a coefficient of variance of particle size distribution of less than about 20%.
13. The method of any one of embodiments 1-12, wherein spheroidal polymer beads have a particle size distribution spread (SPAN) less than about 0.5, or preferably less than about 0.45, or preferably less than about 0.3.
14. The method of any one of embodiments 1-13, wherein the spheroidal polymer beads have a volume median particle diameter of about 5 μm to about 250 μm, or from about 20 to about 200 μm.
15. The method of any one of embodiments 1-14, wherein the spheroidal polymer beads have less size variability and impart less fluid flow resistance compared to the same polymer beads prepared by stirred reactor emulsification.
16. The method of any one of embodiments 1-15, wherein the hydrocolloid dispersed from the spheroidal polymer beads comprises a polysaccharide.
17. The method of embodiment 16, wherein the polysaccharide is a cross-linked polysaccharide.
18. The method of any one of embodiments 16-17, wherein the polysaccharide comprises agarose.
19. The method of any one of embodiments 1-18, wherein the increased mobile phase linear flow velocity does not interfere significantly with binding capacity or selectivity of a ligand binding to the spheroidal polymer beads.
20. A method of increasing linear flow velocity (cm/h) of a mobile phase moving through a stationary phase in a liquid chromatography process comprising: contacting a mobile phase and a stationary phase within a column, wherein the stationary phase comprises a separation matrix comprising spheroidal polymer beads prepared by dispersing a hydrocolloid or other gel forming compound or a water-soluble polymerizable monomer through a plurality of holes in a membrane under conditions sufficient to form spheroidal polymer beads having a volume median particle diameter up to about 300 μm; and wherein a linear flow velocity (cm/h) of the mobile phase is increased by the use of spheroidal polymer beads having a SPAN of less than about 0.6.
21. The method of embodiment 20, wherein the mobile phase flow pressure is between less than about 0.5 MPa, or from about 0.3 MPa to about 0.5 MPa.
22. The method of any one of embodiments 20-21, wherein the mobile phase linear flow velocity is increased with the use of the spheroidal polymer beads compared to polymer beads prepared by stirred reactor emulsification.
23. The method of any one of embodiments 20-22, wherein the increase in linear flow velocity is at least about 50 cm/hr compared to the linear flow velocity using the same polymer beads prepared by stirred reactor emulsification.
24. The method of any one of embodiments 20-23, wherein the increase in linear flow velocity is at least about 100 cm/hr compared to the linear flow velocity using the same polymer beads prepared by stirred reactor emulsification.
25. The method of any one of embodiments 20-24, wherein the increase in linear flow velocity is at least about 200 cm/hr compared to the linear flow velocity using the same polymer beads prepared by stirred reactor emulsification.
26. The method of any one of embodiments 20-25, wherein the increase in linear flow velocity is at least about 250 cm/hr compared to the linear flow velocity using the same polymer beads prepared by stirred reactor emulsification.
27. The method of embodiments 20-25, wherein the linear flow velocity is increased by at least about 10%, at least about 20%, at least about 30% or at least about 40% compared to the linear flow velocity using the same polymer beads prepared by stirred reactor emulsification.
28. The method of any one of embodiments 20-27, wherein the spheroidal polymer beads have substantially uniform particle size as measured by a particle size distribution having a uniformity coefficient of less than about 1.2 or a coefficient of variance of particle size distribution of less than about 20%.
29. The method of any one of embodiments 20-28, wherein spheroidal polymer beads have a particle size distribution spread (SPAN) less than about 0.5, or preferably less than about 0.45, or preferably less than 0.3.
30. The method of any one of embodiments 20-29, wherein the spheroidal polymer beads have a volume median particle diameter of about 5 μm to about 250 μm, or preferably about 20 to about 200 μm.
31. The method of any one of embodiments 20-30, wherein the spheroidal polymer beads have less size variability and impart less fluid flow resistance compared to the same polymer beads prepared by stirred reactor emulsification.
32. The method of any one of embodiments 20-31, wherein the hydrocolloid dispersed from the spheroidal polymer beads comprises a polysaccharide.
33. The method of embodiment 32, wherein the polysaccharide is a cross-linked polysaccharide.
34. The method of any one of embodiments 32-33, wherein the polysaccharide comprises agarose.
35. The method of any one of embodiments 20-34, wherein the increased mobile phase linear flow velocity does not interfere significantly with binding capacity or selectivity of a ligand binding to the spheroidal polymer beads.
36. A separation matrix for liquid chromatography, comprising: a stationary phase housed within a column, wherein the stationary phase comprises a separation matrix comprising spheroidal polymer beads prepared by dispersing a hydrocolloid or other gel forming compound or a water-soluble polymerizable monomer through a plurality of holes in a membrane under conditions sufficient to form spheroidal polymer beads having a volume average particle diameter up to about 300 μm and having a SPAN of less than about 0.6, wherein the stationary phase permits a mobile phase to pass through the stationary phase in the column at an increased linear flow velocity (cm/h) compared to a stationary phase comprising spheroidal polymer beads having a SPAN greater than 0.6.
37. The separation matrix of embodiment 36, wherein the mobile phase flow pressure is between less than about 0.5 MPa, or from about 0.3 MPa to about 0.5 MPa.
38. The separation matrix of any one of embodiments 36-37, wherein the mobile phase linear flow velocity is increased with the use of the spheroidal polymer beads compared to polymer beads prepared by stirred reactor emulsification.
39. The separation matrix of any one of embodiments 36-38, wherein the increase in linear flow velocity is at least about 50 cm/hr, at least about 100 cm/hr, at least about 200 cm/hr, or at least about 250 cm/hr compared to the linear flow velocity using the same polymer beads prepared by stirred reactor emulsification.
40. The separation matrix of any one of embodiments 36-39, wherein the linear flow velocity is increased by at least about 10%, at least about 20%, at least about 30% or at least about 40% compared to the linear flow velocity using the same polymer beads prepared by stirred reactor emulsification.
41. The separation matrix of any one of embodiments 36-40, wherein spheroidal polymer beads have a particle size distribution spread (SPAN) less than about 0.5, or preferably less than about 0.45.
42. The separation matrix of any one of embodiments 36-41, wherein the spheroidal polymer beads have less size variability and impart less fluid flow resistance compared to the same polymer beads prepared by stirred reactor emulsification.
43. The separation matrix of any one of embodiments 36-42, wherein the hydrocolloid dispersed to from the spheroidal polymer beads comprises a polysaccharide, preferably agarose.
43. The separation matrix of any one of embodiments 35-42, wherein the increased mobile phase linear flow velocity does not interfere significantly with binding capacity or selectivity of a ligand binding to the spheroidal polymer beads.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

Agarose beads were prepared by two methods to thereafter compare SPAN of the spheroidal polymer beads using the same formulation under different preparations and analyze impact on linear velocity flow of a mobile phase when contacting the spheroidal polymer beads in a column. The beads were not bound to any ligand to have an equal comparison to beads and the ability for liquid to flow there through as the ligands do not impact maximum velocity.

Polymer beads emulsified in a stirred reactor (listed as Comparative Examples 1-5 in Table 1 below) were prepared by preparation of an agarose solution that was added into an emulsion medium, which were thereafter transferred into an emulsion reactor (also referred to as a stirred reactor emulsification) and then cross-linked as summarized in the following method description.

### Preparation of Agarose Solution

An agarose solution was prepared in a batch reactor by adding 61 g agarose to 1000 ml of distilled water, under stirring for 2 hours at 93° C. After 2 hours, the resulting solution was cooled to 70° C. in preparation for transfer to an emulsion medium.

### Emulsion Medium

An emulsion medium was prepared by adding 119 g of ethyl cellulose (Ethocel N50) to 1000 ml toluene in an emulsion reactor, heating to 70° C. for 2 hours and then subsequently cooling to 60° C. in readiness for the agarose solution addition.

Transfer of Agarose Solution to Emulsion Reactor (a 3 Liter Jacketed Vessel with Loop Agitator with Controllable Rotation Speed)

The agarose solution was transferred to the emulsion medium whilst stirring at 90 rpm. Upon formation of agarose gel particles, particle size was controlled and tailored by varying the rotation speed of the stirrer. Particle size was measured by laser diffraction. Samples were taken every 30 minutes to measure particle sizes. If particle size was too large, stirring rotation speed was increased incrementally until the desired particle size was achieved. Once the target size was reached, the resulting emulsion was cooled from 60° C. to <25° C. in approximately 60 minutes. The gel particles were then washed whilst stirring with industrial methylated spirit (IMS) (5 L) for 30 minutes, left to settle overnight and IMS solution decanted (×6). The gel was then washed with distilled water (5 L) for 30 minutes, left to settle overnight and water solution decanted (×6).

### Cross-Linking Step

To 1000 ml of agarose gel at 50° C., 480 g Na₂SO₄ was added and stirred for 30 minutes. 15 mL NaOH 32% and 1.11 g NaBH₄ were added, whilst 93 mL NaOH 32% and 97 mL epichlorohydrin (ECH) were pumped slowly (6 hours) into the solution. The reaction was kept at 50° C. for 16 hours, then the gel was neutralized with 12 mL Acetic acid 60% until pH˜5-6 was reached and then washed with distilled water. The cross-linking step was then repeated.

Spheroidal polymer beads (listed as Examples 1-5 in Table 1 below) were prepared as follows:

### Preparation of Example 1

An agarose phase (dispersed phase) was prepared at neutral pH containing 1.0 kg of distilled water and 61.0 g agarose. The continuous phase consists of mineral oil SIPMED 15 with 1.5% SPAN 80 surfactant in it.

The dispersed monomer phase was prepared in 3 liter jacketed reactor with paddle overhead stirrer by suspension of agarose in water at room temperature. Then, the temperature increased up to 93° C. and keeping stirred at this temperature for 90 minutes. Then temperature set for 80° C. which was injection temperature. The dispersed phase was fed to the membrane at flow rate of 100 ml/min. The membrane was a 6×6 cm (L/d) nickel-based membrane (pure nickel) containing around 300,000 20 μm through holes connecting the continuous and disperse phases. The membrane was treated with a superhydrophobic coating as disclosed in WO2018/109149. The disperse phase was then directed through the membrane into the suspension phase at a rate of 100 ml/min using a gear pump. The membrane was vibrationally excited to a frequency of 48 Hz and amplitude 4.5 mm as the agarose phase was dispersed in the suspension phase, forming a plurality of agarose droplets in the suspension phase. The resultant droplet emulsion was fed into 5 l glass reactor flask under agitation sufficient to suspend the droplets without resizing the droplets. The reactor was then cooled to temperature of 20° C. After separating the agarose beads from the oil phase, washing the beads and cross-linking as described above for the beads prepared using stirred reactor emulsification, the properties for Example 1 were recorded as shown in Table 1.

### Preparation of Example 2

The same methods as preparing Example 1 were used with the exception that frequency of membrane vibration was 38 Hz, amplitude 4.8 mm. Dispersed phase injection rate was 140 ml/min. After separating the agarose beads from oil, washing and cross-linking as described above for the beads prepared using stirred reactor emulsification, the properties for Example 2 were recorded as shown in Table 1.

### Preparation of Example 3

The same methods as preparing Example 1 were used with the exception that frequency of membrane vibration was 27 Hz and amplitude 3.5 mm. Injection rate was 170 ml/min. After separating the agarose beads from oil, washing and cross-linking as described above for the beads prepared using stirred reactor emulsification, the properties for Example 3 were recorded as shown in Table 1.

### Preparation of Example 4

The same methods as preparing Example 1 were used with the exception that frequency of membrane vibration was 29 Hz and amplitude 2.5 mm. Injection rate was 150 ml/min. After separating the agarose beads from oil, washing and cross-linking as described above for the beads prepared using stirred reactor emulsification, the properties for Example 4 were recorded as shown in Table 1.

### Preparation of Example 5

The same methods as preparing Example 1 were used with the exception that frequency of membrane vibration was 24 Hz and amplitude 2.5 mm. Injection rate was 130 ml/min. After separating the agarose beads from oil, washing and cross-linking as described above for the beads prepared using stirred reactor emulsification, the properties for Example 5 were recorded as shown in Table 1.

After preparation each type of bead was packed into a column by fitting the bottom adapter and leaving the top adaptor off. Columns were packed under 4 bar pressure to a 20 cm (+cm) bed height. The pressure vessel was filled with DI water at a temperature between about 20 and 25° C. HiScale 26/40 columns were prepared according to manufacturer's instructions. The resin (polymer beads) were re-suspended in DI water. The volume of slurry needed was calculated to pack the column with a 1.2 compression factor. The slurry was a 70% gel slurry made by washing and settling the gel in DI water. Approximately 170 ml homogenous gel slurry was transferred to the column.

The following method was used to measure pressure flow through the chromatography columns. When all of the slurry was added to the column, the stop plug was reconnected to the bottom adaptor. The liquid level was filled up to the top of the column and then the top adaptor was attached. Water was run through the system for 1-2 minutes to ensure any air bubbles in the lines were flushed out. Pressure was increased by 0.5 bar intervals to reach a pressure of 4 bar, allowing time to settle between each interval. This was done by attaching the tube to top of the column and securely screwing it into place, then the stop plug was removed from the bottom adaptor. The resin was allowed to settle at 0.25±0.05 bar. Then the pressure was increased to 0.5±0.05 bar and allowed enough time to settle. The pressure increases by about 0.5 bar intervals provided time to allow to settle until a pressure of 4±0.05 bar was reached. At 4±0.05 bar it was allowed at least 3 minutes settling time. After the 3 minutes passed, the point at which the packed bed had settled was marked and pressure released until closed.

The data was plotted and used to calculate the flow at 3 bar of pressure. To calculate the linear velocity of the pressure flow, the time taken for the flow of DI water to reach a specified volume was reported and reported.

Table 1 shows the evaluated polymer beads according to preparation method and measuring SPAN and linear velocity for three different beads sizes. The three different sized beads were 49, 66 and 87/88 microns (as shown based on the D50 measurement in Table 1). The SPAN provides a particle size distribution spread calculated by (D90−D 10)/D50 or the diameter of a bead at 90% volume minus the diameter at 10% volume divided by the diameter of the bead at 50% volume, to provide a dimensionless normalized to particle size distribution spread or yield.

Table 1 shows that in all instances the spheroidal polymer beads have decreased SPAN compared to polymer beads prepared using stirred reactor emulsification, indicating more uniform sizing of the polymer beads. The spheroidal polymer beads provide more uniformly sized spherical agarose beads compared to those prepared by stirred reactor emulsification.

TABLE 1

| | Preparation | | | | | Linear Velocity @ |
|---|---|---|---|---|---|---|
| | Method | D10 | D50 | D90 | SPAN | 0.3 MPa (cm/hr) |
| Comparative | Stirred reactor | 33.0 | 49.2 | 68.7 | 0.73 | 270 |
| Example 1 | emulsification | | | | | |
| Example 1 | ‘Jetting’ | 41.3 | 49.8 | 63.6 | 0.45 | 390 |
| Comparative | Stirred reactor | 41.7 | 66.3 | 91.6 | 0.75 | 48 |
| Example 2 | emulsification | | | | | |
| Example 2 | ‘Jetting’ | 56.8 | 66.5 | 81.1 | 0.37 | 790 |
| Comparative | Stirred reactor | 55.4 | 86.0 | 125.7 | 0.82 | 930 |
| Example 3 | emulsification | | | | | |
| Example 3 | ‘Jetting’ | 77.34 | 87.2 | 95.7 | 0.21 | 1000 |
| Comparative | Stirred reactor | 53.3 | 88.0 | 132.5 | 0.9 | 970 |
| Example 4 | emulsification | | | | | |
| Example 4 | ‘Jetting’ | 76.9 | 88.2 | 100.8 | 0.27 | 1120 |
| Comparative | Stirred reactor | 56.7 | 88.6 | 123.1 | 0.75 | 850 |
| Example 5 | emulsification | | | | | |
| Example 5 | ‘Jetting’ | 76.1 | 87.4 | 99.2 | 0.26 | 1100 |

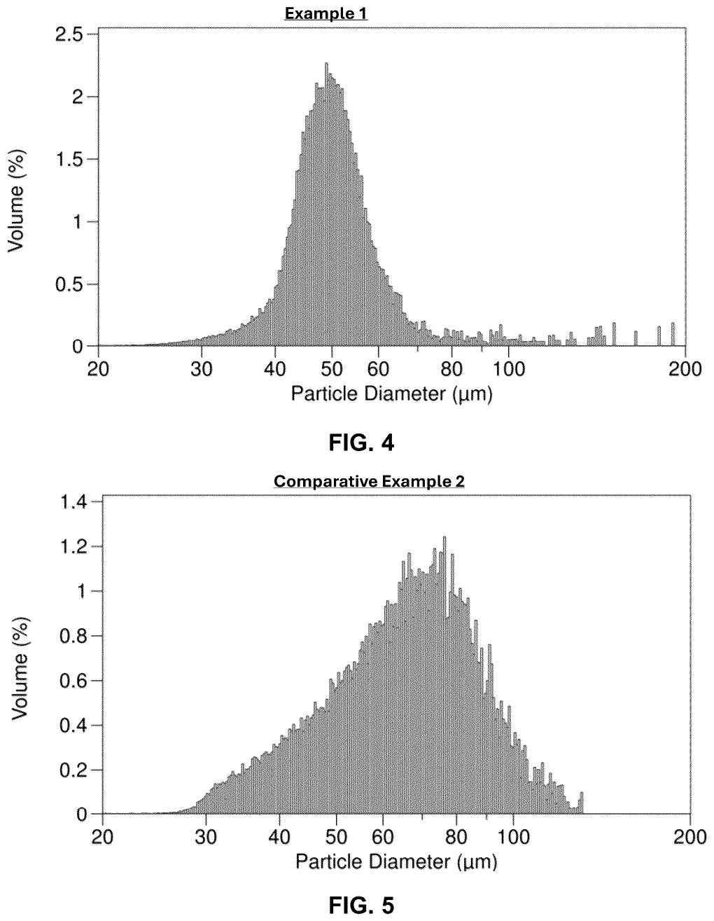

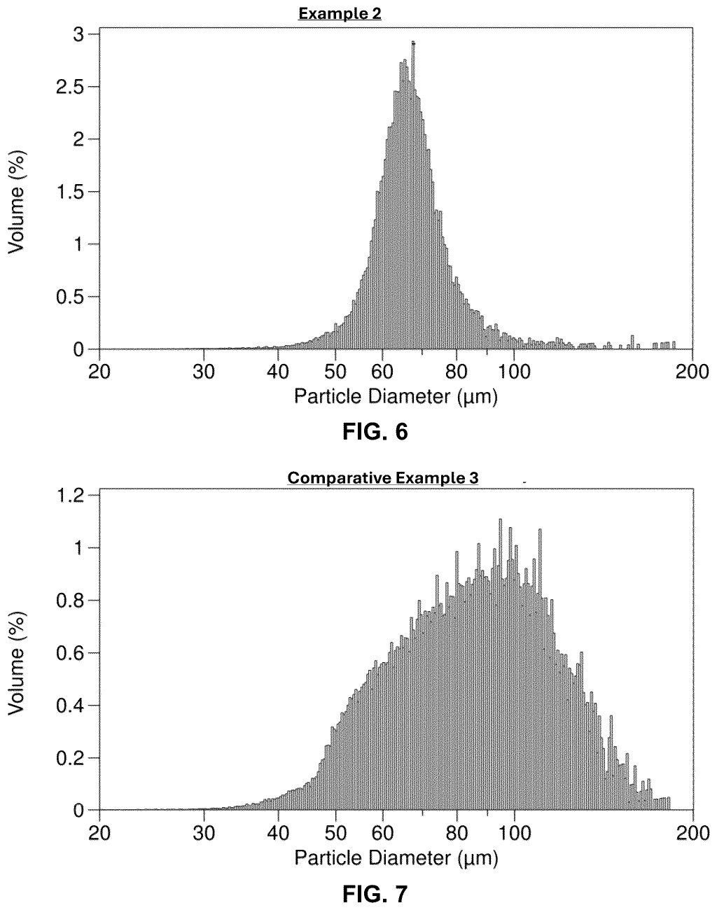

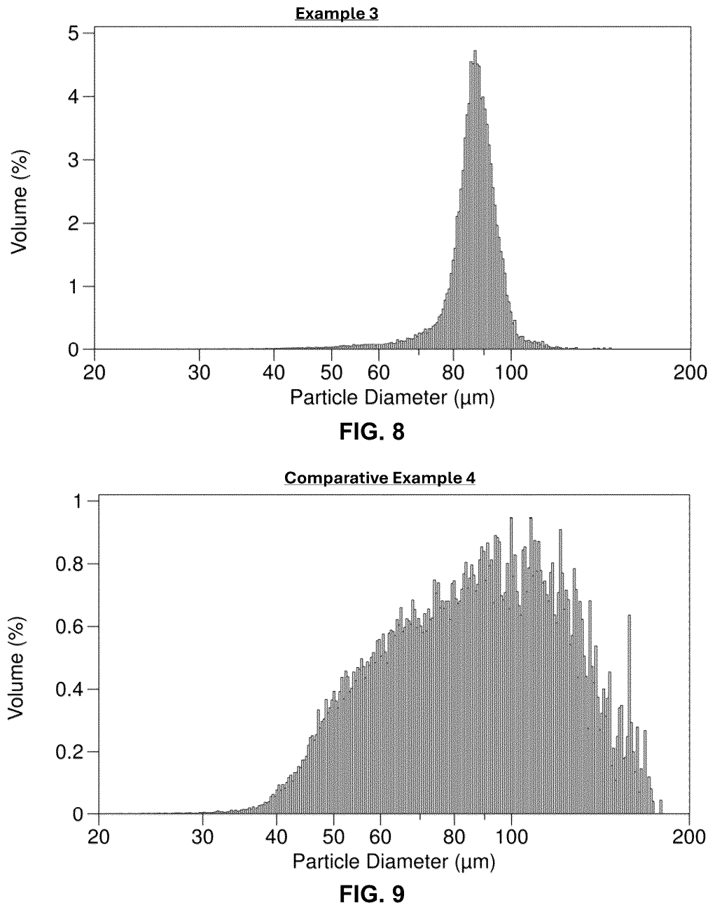

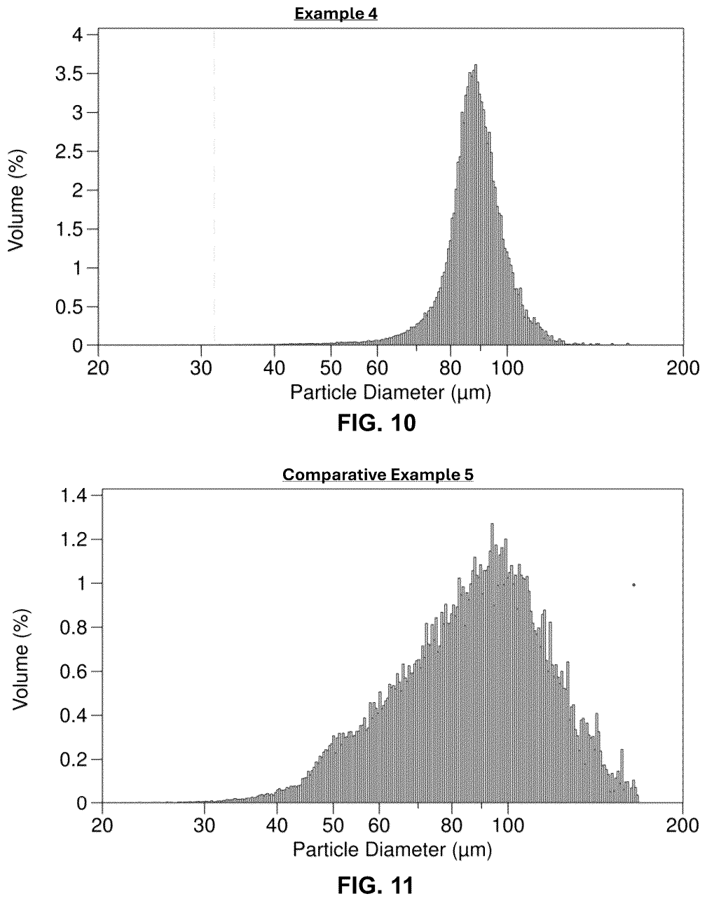

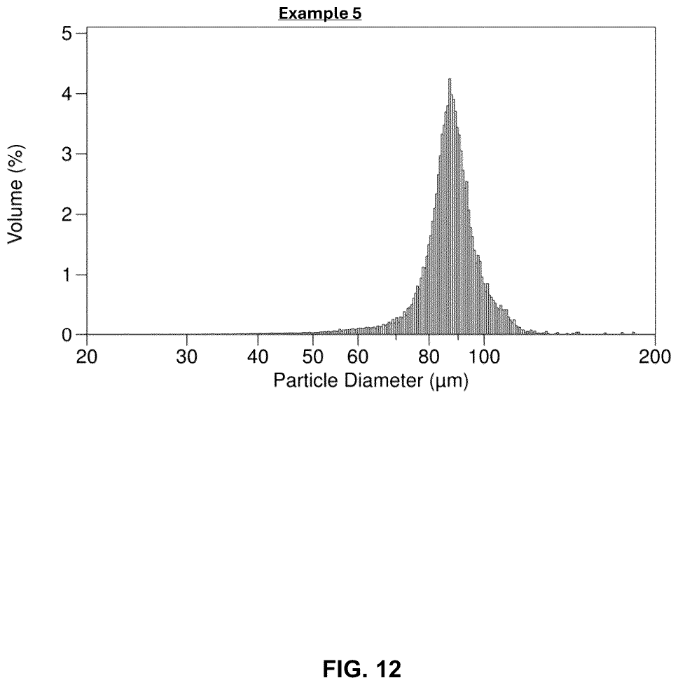

The Coulter Counter test method was used for counting and sizing particles using impedance measurements as depicted in FIGS. 1-10. These methods used a 200 ml round bottom Coulter beaker and 500 ml filter unit with <0.5 μm PES membrane. An electrolyte solution was prepared by dissolving 10 g of NaCl in 1 L DI water and using a filter with <0.5 μm PES membrane filter unit. The Coulter Counter method was conducted using Beckman Coulter Particle Characterization v 3.53 Multisizer 3 software as follows: the SOP specific to the product was loaded; as needed, diluent bottle was topped with 1% NaCl electrolyte solution; beaker was filled with fresh 1% NaCl electrolyte solution; stirrer was turned on; sample confirmed to be in a 50-70% slurry and stirred with a plastic spatula to homogenize; a Pasteur pipette was used to add 3 drops of sample to the Coulter beaker and allowed to stir; analysis was run until 30,000 particles were analyzed; then once complete, the electrode, aperture and stirrer bar were rinsed using DI Water or 1% NaCl solution. The results of each Comparative Example polymer beads (FIG. 1, 3, 5, 7, 9, 11) prepared by stirred reactor emulsification had a greater polymer size variation in comparison to the Example polymer beads (FIG. 2, 4, 6, 8, 10, 12). The decrease in SPAN and uniformity in polymer bead sizes obtained by using jetting technology over the same polymer beads obtained by stirred reactor emulsification both beneficially and unexpectedly permits substantially increased linear velocity through columns packs with the beads as shown in Table 1.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A method of performing liquid chromatography, comprising:
contacting a mobile phase and a stationary phase within a column, wherein the stationary phase comprises a separation matrix comprising spheroidal polymer beads prepared by dispersing a hydrocolloid or other gel forming compound or a water-soluble polymerizable monomer through a plurality of holes in a membrane under conditions sufficient to form spheroidal polymer beads having a volume median particle diameter up to about 300 μm;
wherein the mobile phase linear flow velocity (cm/h) is increased when the spheroidal polymer beads have a SPAN of less than about 0.6 compared to spheroidal polymer beads having a SPAN of more than 0.6.

2. The method of claim 1, wherein the mobile phase flow pressure is between less than about 0.5 MPa, or from about 0.3 MPa to about 0.5 MPa.

3. The method of claim 1, wherein the mobile phase linear flow velocity is increased with the use of the spheroidal polymer beads compared to polymer beads prepared by stirred reactor emulsification, and wherein the increased mobile phase linear flow velocity does not interfere significantly with binding capacity or selectivity of a ligand binding to the spheroidal polymer beads.

4. The method of claim 1, wherein the increase in linear flow velocity is at least about 50 cm/hr, at least about 100 cm/hr, at least about 200 cm/hr or at least about 250 cm/hr compared to the linear flow velocity using the same polymer beads prepared by stirred reactor emulsification.

5. The method of claim 1, wherein the linear flow velocity is increased by at least about 10%, at least about 20%, at least about 30%, or at least about 40% compared to the linear flow velocity using the same polymer beads prepared by stirred reactor emulsification.

6. The method of claim 1, wherein the spheroidal polymer beads have substantially uniform particle size as measured by a particle size distribution having a uniformity coefficient of less than about 1.2 or a coefficient of variance of particle size distribution of less than about 20%, and/or wherein spheroidal polymer beads have a particle size distribution spread (SPAN) less than about 0.5, or preferably less than about 0.45, or preferably less than about 0.3.

7. The method of claim 1, wherein the spheroidal polymer beads have a volume median particle diameter of about 5 μm to about 250 μm, or from about 20 to about 200 μm, and/or wherein the spheroidal polymer beads have less size variability and impart less fluid flow resistance compared to the same polymer beads prepared by stirred reactor emulsification.

8. The method of claim 1, wherein the hydrocolloid dispersed from the spheroidal polymer beads comprises a polysaccharide, a cross-linked polysaccharide, or agarose.

9. A method of increasing linear flow velocity (cm/h) of a mobile phase moving through a stationary phase in a liquid chromatography process comprising:
contacting a mobile phase and a stationary phase within a column, wherein the stationary phase comprises a separation matrix comprising spheroidal polymer beads prepared by dispersing a hydrocolloid or other gel forming compound or a water-soluble polymerizable monomer through a plurality of holes in a membrane under conditions sufficient to form spheroidal polymer beads having a volume median particle diameter up to about 300 μm; and
wherein a linear flow velocity (cm/h) of the mobile phase is increased by the use of spheroidal polymer beads having a SPAN of less than about 0.6.

10. The method of claim 9, wherein the mobile phase flow pressure is between less than about 0.5 MPa, or from about 0.3 MPa to about 0.5 MPa, and wherein the mobile phase linear flow velocity is increased with the use of the spheroidal polymer beads compared to polymer beads prepared by stirred reactor emulsification, and wherein the increased mobile phase linear flow velocity does not interfere significantly with binding capacity or selectivity of a ligand binding to the spheroidal polymer beads.

11. The method of claim 9, wherein the increase in linear flow velocity is at least about 50 cm/hr, at least about 100 cm/hr, at least about 200 cm/hr, or at least about 250 cm/hr compared to the linear flow velocity using the same polymer beads prepared by stirred reactor emulsification.

12. The method of claim 9, wherein the linear flow velocity is increased by at least about 10%, at least about 20%, at least about 30% or at least about 40% compared to the linear flow velocity using the same polymer beads prepared by stirred reactor emulsification.

13. The method of claim 9, wherein the spheroidal polymer beads have substantially uniform particle size as measured by a particle size distribution having a uniformity coefficient of less than about 1.2 or a coefficient of variance of particle size distribution of less than about 20%, and/or wherein spheroidal polymer beads have a particle size distribution spread (SPAN) less than about 0.5, or preferably less than about 0.45, or preferably less than 0.3.

14. The method of claim 9, wherein the spheroidal polymer beads have a volume median particle diameter of about 5 μm to about 250 μm, or preferably about 20 to about 200 μm, and wherein the spheroidal polymer beads have less size variability and impart less fluid flow resistance compared to the same polymer beads prepared by stirred reactor emulsification.

15. The method of claim 9, wherein the hydrocolloid dispersed from the spheroidal polymer beads comprises a polysaccharide, a cross-linked polysaccharide, or agarose.

16. A separation matrix for liquid chromatography, comprising:
a stationary phase housed within a column,
wherein the stationary phase comprises a separation matrix comprising spheroidal polymer beads prepared by dispersing a hydrocolloid or other gel forming compound or a water-soluble polymerizable monomer through a plurality of holes in a membrane under conditions sufficient to form spheroidal polymer beads having a volume average particle diameter up to about 300 μm and having a SPAN of less than about 0.6,
wherein the stationary phase permits a mobile phase to pass through the stationary phase in the column at an increased linear flow velocity (cm/h) compared to a stationary phase comprising spheroidal polymer beads having a SPAN greater than 0.6.

17. The separation matrix of claim 16, wherein the mobile phase flow pressure is between less than about 0.5 MPa, or from about 0.3 MPa to about 0.5 MPa, wherein the mobile phase linear flow velocity is increased with the use of the spheroidal polymer beads compared to polymer beads prepared by stirred reactor emulsification, and wherein the increased mobile phase linear flow velocity does not interfere significantly with binding capacity or selectivity of a ligand binding to the spheroidal polymer beads.

18. The separation matrix of claim 16, wherein the increase in linear flow velocity is at least about 50 cm/hr, at least about 100 cm/hr, at least about 200 cm/hr, or at least about 250 cm/hr compared to the linear flow velocity using the same polymer beads prepared by stirred reactor emulsification, and/or wherein the linear flow velocity is increased by at least about 10%, at least about 20%, at least about 30% or at least about 40% compared to the linear flow velocity using the same polymer beads prepared by stirred reactor emulsification.

19. The separation matrix of claim 16, wherein spheroidal polymer beads have a particle size distribution spread (SPAN) less than about 0.5, or less than about 0.45, and wherein the spheroidal polymer beads have less size variability and impart less fluid flow resistance compared to the same polymer beads prepared by stirred reactor emulsification.

20. The separation matrix of claim 16, wherein the hydrocolloid dispersed to from the spheroidal polymer beads comprises a polysaccharide or agarose.
